(19) United States
(12) Patent Application Publication
(10) Pub. No.: US 2012/0109536 A1
(43) Pub. Date: May 3, 2012

(54) MULTIFUNCTION SENSOR SYSTEM AND METHOD FOR SUPERVISING ROOM CONDITIONS

(75) Inventors: Willem F. Pasveer, Dordrecht (NL); Peter Dirksen, Valkenswaard (NL); Biju K. Sreedharan Nair, Veldhoven (NL)

(73) Assignee: KONINKLIJKE PHILIPS ELECTRONICS N.V., Eindhoven (NL)

(21) Appl. No.: 13/382,934

(22) PCT Filed: Jun. 24, 2010
(86) PCT No.: PCT/IB10/52884

§ 371 Date: Jan. 9, 2012

(30) Foreign Application Priority Data
Jul. 7, 2009 (EP) 09164730.5

(51) Int. Cl. G06F 19/00

(52) U.S. Cl. 702/24

(57) ABSTRACT

The invention refers to a multifunction sensor system and a corresponding method for supervising room conditions, comprising a temperature sensor, a humidity sensor, an ultrasonic transducer for emitting ultrasonic waves and being positioned in a fixed distance to a reflecting fixed reflective surface. For calculating the CO₂ concentration in the supervised room, the time of flight of ultrasonic waves between the transducer and the fixed reflective surface is measured, and the CO₂ concentration is calculated from the output values of the temperature sensor, the humidity sensor and the measured time of flight.

### FIELD OF THE INVENTION

The present invention relates to a multifunction sensor system and a corresponding method for supervising room conditions, especially in a building management system for controlling atmospherical room conditions.

### BACKGROUND OF THE INVENTION

Building management systems require information about the conditions of the rooms of the building, for example, the room occupancy, room temperature, humidity and CO₂ concentration. On the basis of this information, a control of the atmospherical room conditions can be carried out by a heating air conditioning and ventilation (HVAC) system.

The necessary information is derived from measuring values which are provided by different kinds of sensors which are arranged in the respective rooms to be controlled. In common systems, each sensor is provided according to the parameter to be measured, for example, a temperature sensor for providing a present temperature value, a humidity sensor for measuring humidity, and so on. It is also known to combine different kinds of sensors in a multifunction sensor system, like it is disclosed in EP 0 838 792 A2. The multifunction occupancy sensor described therein combines different kinds of sensor functions in one sensor device, each multifunction sensor including different sensors for detecting occupancy, ambient light level, temperature and other parameters.

An item of increasing importance is energy saving, which is seen as vital (for the global) environment. Legislation in North America and Europe requires energy saving measures. Within the lighting industry and building automation, sensors are important enablers for achieving the energy saving effect. This especially refers to occupancy sensors.

To decrease the installation costs of a sensor system in a building, especially if such a system is installed afterwards in an existing building, it is desired to install the sensors in the respective rooms without installing any new wiring. The lower installation costs justify the extra expenses of the wireless sensors. It is desired not only to enable a wireless communication between the sensors and a control device which receives the measured data but also to provide a wireless energy supply of the sensors. Such an independent energy supply can be achieved by battery powered sensors or by energy harvesting, for example, by the use of solar energy or the like. This can only be realized with sensors with an ultra low power consumption to realize a long lifetime, in the order of ten years or longer.

For control by the heating air conditioning and ventilation system (HVAC), temperature, humidity, CO₂ concentration and room occupancy are very important parameters to enable a full room control. Moreover, when the actual CO₂ concentration is known, adjustment of ventilation or even warning signals can be provided. In commonly known systems, these different parameters have to be measured by a multifunction sensor system comprising a sensor for each parameter, increasing the overall energy consumption of the sensor system. Sensors for occupancy, temperature, humidity and CO₂ concentration are hard to integrate in one single wireless sensor device that measures these parameters. The power requirements of the such a system with one sensor for each parameter are high and shorten the lifetime for the multifunction sensor system when it is run on an independent energy supply like a battery. The high energy consumption also causes problems in employing independent energy harvesting methods like solar cells or the like.

It is therefore an object of the present invention to provide a multifunction sensor system and method for supervising room conditions to measure the parameter values necessary for controlling the atmospheric room conditions with low constructional effort and low power consumption, making it possible to provide a true wireless sensor system, decreasing the installation costs.

### SUMMARY OF THE INVENTION

This object is achieved by a multifunction sensor system for supervising room conditions, comprising a temperature sensor, a humidity sensor, an ultrasonic transducer provided to emit ultrasonic waves and being positioned in a fixed distance to a fixed reflective surface capable of reflecting ultrasonic waves, a measuring device for measuring the time of flight of ultrasonic waves between the transducer and the fixed reflective surface, and a calculation device for calculating a CO₂ concentration from the output values of the temperature sensor and the humidity sensor and the measured time of flight.

The multifunction sensor system according to the present invention only comprises three different detecting units for deriving four different room parameters. While the humidity sensor and the temperature sensor are provided in a common way to measure the temperature and humidity value, the ultrasonic transducer can be used to detect the room occupancy on the one hand and to measure the time of flight of emitted ultrasonic waves between the transducer and the fixed reflective surface on the other hand. From the time of flight value, the CO₂ concentration can be derived by means of the temperature and humidity values provided by the respective sensors.

Using an ultrasonic transducer for the above purpose makes it possible to do without an extra CO₂ sensor, lowering the constructional effort and the overall construction costs of the multifunction sensor system as well as its energy consumption, making it possible to construct a system which runs completely wireless. Consequently, the installation of a multifunction sensor system according to the present invention is easy and inexpensive. Ultrasonic transducers are commonly known for detecting the room occupancy, their integration in the inventive sensor system and the use of run-time effects of the emitted ultrasonic waves for indirectly deriving the CO₂ concentration provides a very effective general concept.

In a preferred embodiment, the ultrasonic transducer is provided to emit ultrasonic waves at a front side and at a back side, the multifunction sensor system further comprising an ultrasonic wave guide, the transducer being arranged with the back side facing a first end of the ultrasonic wave guide.

In this arrangement the time of flight of the ultrasonic waves can be measured between the back side of the transducer and the fixed reflective surface, while the ultrasonic waves emitted at the opposed front side of the transducer can be used for detecting the room occupancy.

According to another preferred embodiment, the fixed reflective surface is a mirror which is arranged at an opposed second end of the ultrasonic wave guide.

According to another embodiment of the invention, the ultrasonic wave guide has a form of a straight pipe, the back side of the transducer and a mirror facing each other on a common pipe axis.

According to a different embodiment, the ultrasonic wave guide has the form of a bended horn. The bending parameter is correctly chosen so that no signal degradation will be introduced, and as such the thickness of the whole ultrasonic transducer unit can be decreased.

A building management system according to the present invention comprises a multifunction sensor system as described above and control devices for controlling the room conditions.

An ultrasonic transducer unit for use in a multifunction sensor system as described above comprises an ultrasonic transducer provided to emit ultrasonic waves at least at a back side, an ultrasonic wave guide for guiding the ultrasonic waves at the back side of the transducer, a fixed reflective surface arranged at the end of the wave guide opposed to the transducer, and a device for measuring the time of flight of ultrasonic waves between the transducer and the fixed reflective surface.

In a preferred embodiment this ultrasonic transducer is also provided to emit ultrasonic waves at a front side, enabling its use for detecting room occupancy in this direction.

This reception unit may be connected to the calculation device for deriving the CO₂ concentration with help of measured values output by the temperature sensor and the humidity sensor.

A method for supervising room conditions according to the present invention comprises measuring a room temperature, measuring a room humidity, emitting ultrasonic waves from an ultrasonic transducer to a fixed reflective surface positioned in a fixed distance to the transducer which is capable of reflecting ultrasonic waves, and measuring a time of flight of ultrasonic waves between the transducer and the fixed reflective surface, followed by calculating a CO₂ concentration from the measured room temperature, the measured humidity and the measured time of flight.

This method is based on a fact that the velocity of ultrasonic waves in gases is given by a relation including a temperature, the pressure and the molecular weight in gas as parameters. When temperature and pressure are known, changes in molecular weight can be detected which in turn indicate the presence of CO₂.

In a preferred embodiment of this method according to the present invention, an occupancy detection is conducted by means of the transducer. This means that the transducer has the above described additional function of indicating the room occupancy by emitting and receiving ultrasonic waves.

According to one preferred embodiment, this method comprises the emission of ultrasonic waves from opposite sides of the transducer, wherein the occupancy detection is conducted at a side of the transducer opposite to the fixed reflective surface.

According to another preferred embodiment, the occupancy detection is conducted at a side of the transducer facing the fixed reflective surface.

According to one further embodiment of this inventive method, the ultrasonic waves are guided between the transducer and the fixed reflective surface within a wave guide.

Another preferred embodiment of the method according to the present invention comprises communicating at least the measured room temperature value, the measured humidity value and the measured time of flight value to a calculation device for calculating the CO₂ concentration.

This calculation device can be a computer connected wirelessly with different multifunction sensor systems in the rooms of a building.

In a preferred embodiment of the present invention, the method as described above may comprise a calibration step in which the distance between the transducer and a wall structure is calculated on the basis of a time of flight measurement of ultrasonic waves between the transducer and the wall structure under predetermined conditions.

This embodiment of the supervising method comprises a self-learning step about the position of a wall structure, for example, so that the distance between the transducer and the wall structure is known. In the following process, this distance could then be used as well as a parameter for calculating the CO₂ concentration.

The predetermined conditions under which the calibration step is carried out may include a predetermined CO₂ concentration. The calibration step can further be carried out at a predetermined day time.

For example, the self-learning step is carried out at night, which can be assumed as a time of day at which the CO₂ concentration has a constant value which is known to the system. It is also possible to start a measurement after the installation of the system with an average value and adjust this value at night under predetermined conditions.

Further aspects and benefits of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The above mentioned features, aspects and advantages of the present invention will become better understood from the follow description with reference to the accompanying drawings where:

FIG. 1 is a schematic outline of an embodiment of a building management system according to the present invention; and

FIG. 2 is a schematic view of a preferred embodiment of the multifunction sensor system according to the present invention.

### DETAILED DESCRIPTION OF EMBODIMENTS

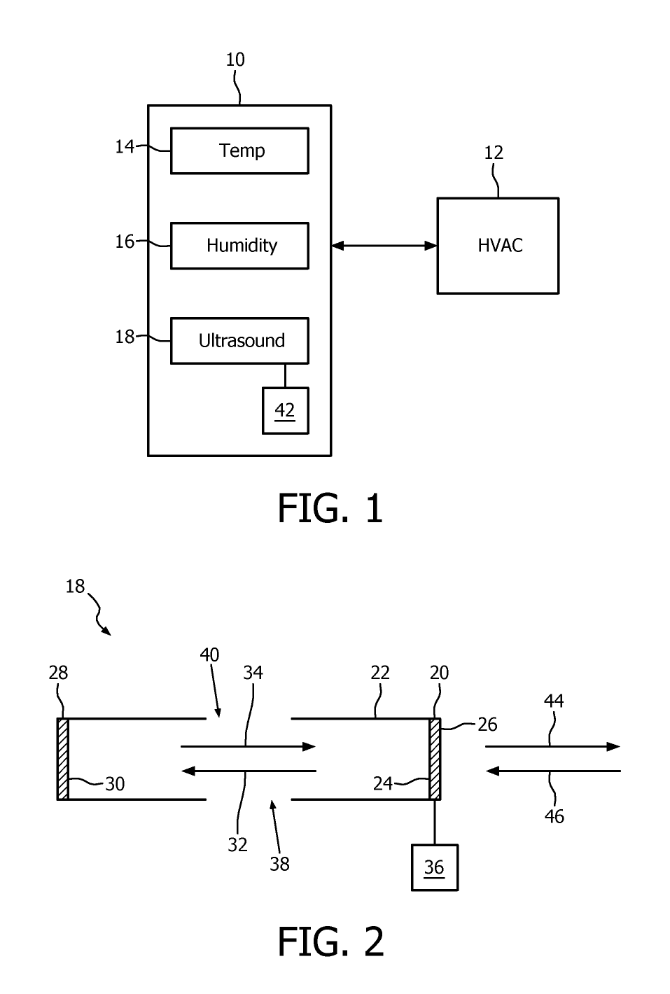

The building management system as shown in FIG. 1 comprises a multifunction sensor system generally marked by reference number 10, and a control system on the right side of the figure marked by reference number 12. The multifunction sensor system 10 is provided for supervising the conditions of a room of a building which is to be controlled by the building management system. For this purpose different parameters concerning the state of the room are measured and derived by the multifunction sensor system 10 and transmitted wirelessly to the control system 12. The control system 12 can comprise a heating air conditioning and ventilation (HVAC) system for managing the atmospherical conditions of the room in question, i.e., temperature, humidity and so on. For example, the present atmospherical conditions and the occupancy state of the room is measured, and the measured data are transmitted wirelessly from the multifunction sensor system 10 to the control system 12, which in turn sets suitable values for the heating, air conditioning and ventilation of the room.

For monitoring the room conditions the multifunction sensor system comprises a temperature sensor 14, a humidity sensor 16 and an ultrasonic transducer unit 18. The ultrasonic transducer unit 18 provides two functions. First, it is used for detecting the room occupancy by emitting ultrasonic waves and deriving the occupancy state by reception of reflected ultrasonic waves. Moreover, as will be explained in detail with reference to the construction details of the ultrasonic transducer unit 18, this unit is used for measuring time of flight of ultrasonic waves emitted by the transducer which is part of the transducer unit 18 and a reflecting wall structure as a fixed reflective surface, and for deriving a CO₂ concentration from the measured time of flight using the measured data of temperature and humidity which are provided by the respective temperature sensor 14 and humidity sensor 16. As a result, the multifunction sensor system provides four important values for managing and controlling the room conditions, namely temperature, humidity, occupancy and CO₂ concentration. These values can be transferred directly in a wireless way to the control system 12.

With reference to FIG. 2, the ultrasonic transducer unit 18 for use in the multifunction sensor system 10 according to FIG. 1 comprises an ultrasonic transducer 20 being arranged at one end of a wave guide 22 which has the form of a straight pipe. At one end of the pipe 22, the transducer 20 is arranged so that its back side 24 faces the pipe 22. The front side 26 of the ultrasonic transducer 20 is free. Both opposing sides 24 and 26 of the ultrasonic transducer 20 are provided to emit ultrasonic waves.

On the other end of pipe 22, a mirror 28 is arranged as a fixed reflective surface so that both ends of the pipe 22 are closed by the mirror 28 on the one hand and the transducer 20 on the other hand. The inner side 30 of the mirror 28 which faces the ultrasonic transducer 20 is capable of reflecting ultrasonic waves travelling on the back side 24 of the ultrasonic transducer 20 through the pipe 22 to the mirror 28. The travelling direction of these ultrasonic waves emitted by the back side 24 of the transducer 20 is marked by an arrow 32. The travelling direction of the ultrasonic waves reflected by the mirror 30 is marked by another arrow 34. These reflective ultrasonic waves can be received by a respective reception part of the ultrasonic transducer 20. The ultrasonic transducer unit 18 also comprises a measuring means for measuring a time of flight of the ultrasonic waves between the transducer 20 and the mirror 28. For this purpose a measuring device 36 is provided to measure auto derive the time of flight of the ultrasonic waves over the distance 2L, which is two times the length L of the pipe 22 between the transducer 20 and the mirror 28. It is noted that this measuring device 36 is only depicted schematically and can be provided in any form as part of the multifunction sensor system 10. For the purpose of the present invention any device for measuring the time between the emission of ultrasonic waves at the back side 24 of the transducer 20 and the reception of the reflected waves at the transducer 20 is suited.

The pipe 22 is provided with two air inlets 38,40 at two opposed sides at the side walls of the pipe 22. Through these air inlets 38,40, atmospheric environmental air can be introduced into the pipe 22 so that it is provided that the atmospheric conditions within the wave guide correspond to the rooms conditions.

From the measured time of flight of the ultrasonic waves, the CO₂ concentration in the air filling the pipe 22 is derived in the following way. Over a fixed distance the absorption of the ultrasonic waves by air will be a function of the CO₂ content. Due to the fact that there is a fixed distance L between the ultrasonic transducer 20 and the mirror 28 it is possible to calculate the absorption coefficient from a time of flight (ToF) measurement.

The speed of sound is a function of temperature, pressure, humidity and CO₂ content, as given by the following equation (1):

$${C}_{0} ( t , p , {x}_{w} , {x}_{c} ) = {a}_{0} + {a}_{1} t + {a}_{2} {t}^{2} + ( {a}_{3} + {a}_{4} t + {a}_{5} {t}^{2} ) {x}_{w} + ( {a}_{6} + {a}_{7} t + {a}_{8} {t}^{2} ) p + ( {a}_{9} + {a}_{10} t + {a}_{11} {t}^{2} ) {x}_{c} + {a}_{12} {x}_{w}^{2} + {a}_{13} {p}^{2} + {a}_{14} {x}_{c}^{2} + {a}_{15} {x}_{w} {px}_{c} \qquad ( 1 )$$

In this equation (1) c₀ is the zero frequency speed of sound, t is the temperature in degrees Celsius, x_{w} and x_{c} are the water vapor and carbon dioxide mole fractions respectively and p is the pressure in Pa (N/m²). The coefficients aᵢ are predetermined constants which can be taken from a look up table.

For a fixed distance L, the time of flight (ToF) is given by the following equation (2):

$$ToF = \frac{2 L}{C} \qquad ( 2 )$$

Changes of the time of flight (ToF) will be contributed by the difference in velocity which will be caused by changes of pressure, temperature and molecular weight in the gas, according to equation (1) as given above. As temperature and humidity can be directly measured by the humidity sensor 16 and the temperature sensor 14, changes in molecular weight can be detected which in turn indicate the presence of CO₂. The terms of equation (1) including the pressure are assumed to be neglected because of the very small values of the respective constants aᵢ. It is, however, possible to acknowledge the influence of pressure by measuring a pressure value by a suitable pressure sensor and to introduce the measured value into the calculation according to equation (1).

The calculation means for calculating the CO₂ concentration from the output values of the temperature sensor 14, the humidity sensor 16 and the time of flight ToF measured by the measuring unit 36 can be a calculating device 42 which is arranged directly at the transducer unit 18 near the humidity sensor 16 and the temperature sensor 14 (see FIG. 1). It is, for example, possible to combine the ultrasonic transducer unit 18, the temperature sensor 14, the humidity sensor 16 and the calculation unit 42 in one independent device installed in a room to be monitored. According to another embodiment it is possible to arrange the calculation means 42 as a remote unit in another part of the building management system, for example, near the control system 12 at a central place of the building so that the output values of the temperature sensor 14 and the humidity sensor 16 and the measured time of flight (ToF) have to be transmitted wirelessly to a reception unit connected to the calculation device 42 so that the calculation of the CO₂ concentration is carried out at a place separated from the place of measurement. In cases where a pressure sensor as an additional sensor for providing a pressure value is provided, it is to be understood that the output value of the pressure sensor is transmitted to the calculating device (42) in the same way as the output values of the temperature sensor (14) and the humidity sensor (16).

As an additional parameter of the room condition, the room occupancy is detected by the ultrasonic transducer unit. For this purpose ultrasonic waves are emitted by the front side 26 of the ultrasonic transducer 20 (FIG. 2). Presence detection in front of the front side 26 can be derived from reflected ultrasonic waves which reach the transducer 20. The main travelling direction of waves emitted by the front side 26 is indicated by an arrow 44, while the reflected waves are indicated by another arrow 46. The room occupancy is another important parameter for managing the room conditions, and so information concerning the occupancy is also transmitted to the control system 12 of the building management system. For example, the light in the respective room can be turned on or turned off dependent on the room occupancy.

It is clear from the above that the multifunction sensor system according to the present invention provides for important monitoring parameters, namely temperature, humidity, CO₂ concentration and room occupancy by using a temperature sensor, a humidity sensor and an ultrasonic transducer which is used for occupancy detection and a time of flight measurement at the same time. Wherever necessary, pressure can be measured as an additional monitoring parameter, giving a supplemental information about the room condition.

The use of only three energy consuming sensor devices makes it possible to lower the energy consumption of the multifunction sensor system as such. For this reason the multifunction sensor system 10 according to FIG. 1 can be provided with an independent energy source, like a battery, a solar cell for harvesting energy from the environment, or the like. It is also possible to equip each of the temperature sensor 14, the humidity sensor 16 and the ultrasonic transducer unit 18 with an independent energy supply. As a wireless communication is provided and no wiring is necessary for energy supply within the room, the installation of the multifunction sensor system 10 is easy and inexpensive. This goes along with other advantages, as such a system can easily be employed in the building without changing the wiring of the rooms.

The sensor devices available on the market already have very low power characteristics. For example, as sensor like SHT75 available from Sensirion can be used for temperature or humidity measurement, which uses ca. 500 μA for a maximum of 210 ms (in case of a desired 14 bit accuracy). When this sensor is in sleep mode, it consumes only 0.3 μA. A possible microcontroller for this sensor is the model No. MSP430 with a very low sleep mode current consumption of ca. 0.3 to 0.5 μA. With such sensors, the desired low energy consumption characteristics can easily be achieved.

The present invention is not limited to the use of a straight pipe as an ultrasonic wave guide, as it is shown in FIG. 2. It is also possible to use the form of a bended horn as a wave guide, with a bending parameter correctly chosen so that no signal degradation will be introduced, and as such the thickness of the whole device can be decreased.

According to another embodiment of the present invention, no pipe structure with a mirror fixed in a predetermined distance at the back of the ultrasonic transducer 20 is needed. In this case the system can be self-learning or self-calibrating to calculate the fixed distance between the transducer 20 and a reflecting wall structure automatically. This calibration can take place on the basis of a time of flight measurement of ultrasonic waves between the transducer and the wall structure under predetermined conditions. These predetermined conditions can include a known CO₂ concentration, for example at a predetermined day time. For example, the CO₂ concentration in a room at night is known. On this basis, this self-calibrating procedure as described above can take place at a predetermined time in the night. It is also possible to start with the measurement directly after the installation of the system with a given average value for the CO₂ concentration and to adjust the system at night under predetermined conditions with a known CO₂ concentration. Once the distance is calculated, the time of flight measurement can be continued like explained above to derive the CO₂ concentration.

The above description is intended to be merely illustrative of the present invention and should not be construed as limiting the appended claims to any particular embodiment or group of embodiments. While the invention has been described in detail with reference to specific exemplary embodiments thereof, different modifications and changes may be made thereto without departing from the spirit and scope of the invention as set force in the claims. The specification and drawings are accordingly to be regarded in an illustrated manner and are not intended to limit the scope of the claims. In the claims, the word “comprising” does not exclude other elements or steps, and the indefinite article “a” or “an” does not exclude a plurality. Any reference signs in the claims should not be construed as limiting the scope.

1. A multifunction sensor system for supervising room conditions, the system comprising:
a temperature sensor,
a humidity sensor,
an ultrasonic transducer configured to emit ultrasonic waves and being positioned in a fixed distance to a fixed reflective surface capable of reflecting ultrasonic waves,
a measuring device for measuring a time of flight of ultrasonic waves between the transducer and the fixed reflective surface, and
a calculation device for calculating a CO₂ concentration from the output values of the temperature sensor and the humidity sensor and the measured time of flight.

2. Multifunction sensor system according to claim 1, wherein the ultrasonic transducer has a front side and a back side and is provided to emit ultrasonic waves at the front side and at the back side, said multifunction sensor system further comprising an ultrasonic wave guide, the transducer being arranged with the back side facing a first end of the ultrasonic wave guide.

3. Multifunction sensor system according to claim 2, wherein the fixed reflective surface is a mirror which is arranged at an opposed second end of the ultrasonic wave guide.

4. Multifunction sensor system according to claim 2, wherein said ultrasonic wave guide has the form of a straight pipe, the back side of the transducer and the mirror facing each other on a common pipe axis.

5. Multifunction sensor system according to claim 2 wherein said ultrasonic wave guide has the form of a bended horn.

6. Building management system, comprising a multifunction sensor system according to claim 1 and at least one control device for controlling one or more room conditions.

7. An ultrasonic transducer unit for use in a multifunction sensor system according to claim 1, the ultrasonic transducer unit comprising:
an ultrasonic transducer that has a front side and a back side and is provided to emit ultrasonic waves at least at the back side,
an ultrasonic wave guide for guiding the ultrasonic waves at the back side of the transducer,
a fixed reflective surface arranged at an end of the wave guide opposed to the transducer, and
a measuring device for measuring the time of flight of ultrasonic waves between the transducer and the fixed reflective surface.

8. Ultrasonic transducer unit according to claim 7, wherein said ultrasonic transducer is further provided to emit ultrasonic waves at the front side.

9. A method for supervising room conditions, the method comprising:
measuring a room temperature,
measuring a room humidity,
emitting ultrasonic waves from an ultrasonic transducer to a fixed reflective surface positioned in a fixed distance to the transducer which is capable of reflecting ultrasonic waves, and
measuring a time of flight of ultrasonic waves between the transducer and the fixed reflective surface, followed by calculating a CO₂ concentration from the measured room temperature, the measured humidity and the measured time of flight.

10. Method according to claim 9, comprising the conduction of an occupancy detection by means of the transducer.

11. Method according to claim 10, comprising the emission of ultrasonic waves from opposite sides of the transducer, wherein the occupancy detection is conducted at a side of the transducer opposite to the fixed reflective surface.

12. Method according to claim 10, wherein the occupancy detection is conducted at a side of the transducer facing the fixed reflective surface.

13. Method according to claim 9 comprising guiding the ultrasonic waves between the transducer and the fixed reflective surface within a wave guide.

14. Method according to claim 9, comprising communicating at least the measured room temperature value, the measured humidity value and the measured time of flight value to a calculation device for calculating the CO₂ concentration.

15. Method according to claim 9 comprising a calibration step in which the distance between the transducer and the fixed reflective surface is calculated on the basis of a time of flight measurement of ultrasonic waves between the transducer and the fixed reflective surface under predetermined conditions.
